(19) United States
(12) Patent Application Publication
(10) Pub. No.: US 2026/0151733 A1
(43) Pub. Date: Jun. 4, 2026

(54) METHOD FOR DECOMPOSING CHLORINE GAS AND METHOD FOR REMOVING THE SAME

(71) Applicant: Resonac Corporation, Tokyo (JP)

(72) Inventors: Kunchan LEE, Minato-ku, Tokyo (JP); Kazuki IWAGAKI, Minato-ku, Tokyo (JP); Toshinori MORIYA, Minato-ku, Tokyo (JP)

(73) Assignee: Resonac Corporation, Tokyo (JP)

(21) Appl. No.: 19/126,715

(22) PCT Filed: Nov. 7, 2023
(86) PCT No.: PCT/JP2023/039972

§ 371 Date: May 2, 2025

(30) Foreign Application Priority Data
Nov. 8, 2022 (JP) 2022-178742

(51) Int. Cl. B01D 53/86; B01D 53/94

(52) U.S. Cl. CPC B01D 53/8659; B01D 53/94; B01D 2255/1026; B01D 2255/20715; B01D 2257/2025; B01D 2258/01

(57) ABSTRACT

[Problem] To provide a chlorine gas removal means capable of removing chlorine gas contained in exhaust gas and the like with high efficiency.

[Solution to Problem] A method for decomposing chlorine gas, including a step of bringing a gas containing chlorine gas into contact with a chlorine gas decomposition catalyst in the presence of water, in which the chlorine gas decomposition catalyst includes a ruthenium material (X), and the ruthenium material (X) includes at least one selected from the group consisting of ruthenium and a ruthenium compound.

### TECHNICAL FIELD

The present invention relates to a method for decomposing chlorine gas and a method for removing chlorine gas from exhaust gas employing the same.

### BACKGROUND ART

Chlorine gas may be contained in gases exhausted from, for example, manufacturing courses of compounds and various industrial processes. Chlorine gas is toxic and required to be removed, and therefore various methods have been conventionally employed to remove it.

For example, Patent Literatures 1 and 2 disclose a method for removing chlorine gas by bringing exhaust gas containing chlorine gas into contact with an alkaline solution. Moreover, Patent Literatures 3 and 4 disclose a method for removing chlorine gas by making halogen-based gases such as chlorine gas absorbed onto an adsorbent (an agent for rendering the gas harmless) containing a zeolite.

### CITATION LIST

### Patent Literature

[Patent Literature 1] JP2005-305414A
[Patent Literature 2] JP2008-110339A
[Patent Literature 3] JP2008-229610A
[Patent Literature 4] JP2016-155072A

### SUMMARY OF INVENTION

### Technical Problem

However, conventional methods for removing chlorine gas have had room for further improvement in terms of efficiency of removing chlorine gas.

Therefore, an object of the present invention is to provide a method for removing chlorine gas by which chlorine gas contained in exhaust gas and the like can be removed with high efficiency, and the like.

### Solution to Problem

The present inventors have found as a result of diligent investigations that chlorine gas can be decomposed and removed with high efficiency by bringing gas containing chlorine gas into contact with a specific chlorine gas decomposition catalyst in the presence of water, and have thus completed the present invention.

The present invention relates to, for example, the following [1] to [6].

[1]

A method for decomposing chlorine gas, comprising a step of bringing a gas containing chlorine gas into contact with a chlorine gas decomposition catalyst in the presence of water,
wherein the chlorine gas decomposition catalyst comprises a ruthenium material (X), and
the ruthenium material (X) comprises at least one selected from the group consisting of ruthenium and a ruthenium compound.
   [2]

The method for decomposing chlorine gas according to [1], wherein the ruthenium material (X) comprises ruthenium.

[3]

The method for decomposing chlorine gas according to [1] or [2], wherein the ruthenium material (X) comprises a Ru—Zr alloy as the ruthenium compound.

[4]

The method for decomposing chlorine gas according to any one of [1] to [3], wherein the ruthenium material (X) comprises ruthenium oxide as the ruthenium compound.

[5]

The method for decomposing chlorine gas according to any one of [1] to [4], wherein the chlorine gas decomposition catalyst comprises a support and the ruthenium material (X) supported on the support.

[6]

A method for removing chlorine gas contained in exhaust gas, comprising a step of removing the chlorine gas by decomposing the chlorine gas using the method for decomposing chlorine gas according to any one of [1] to [5].

### Advantageous Effects of Invention

According to the chlorine gas of the present invention, chlorine gas contained in exhaust gases and the like can be removed with high efficiency.

### BRIEF DESCRIPTION OF DRAWINGS

FIG. 1 is an XRD pattern of the chlorine gas decomposition catalyst used in Example 1.

FIG. 2 is an XRD pattern of the chlorine gas decomposition catalyst used in Example 2.

FIG. 3 is an XRD pattern of the chlorine gas decomposition catalyst used in Example 3.

FIG. 4 is an XRD pattern of the chlorine gas decomposition catalyst used in Comparative Example 1.

FIG. 5 is an XRD pattern of the chlorine gas decomposition catalyst used in Comparative Example 2.

FIG. 6 is a configuration view of one aspect of an exhaust gas treatment apparatus that can be used in the present invention.

### DESCRIPTION OF EMBODIMENT

The present invention will be described in more detail below.

In a numerical range described in the present disclosure, the upper limit value or lower limit value of the numerical range may be replaced with the values shown in Examples. Furthermore, the lower limit value and upper limit value of the numerical range are arbitrarily combined with the lower limit value or upper limit value of other numerical range. In the expression numerical range “AA to BB,” the numerical values at both ends, AA and BB, are included in the numerical range as a lower limit value and an upper limit value, respectively.

### [Decomposition Method of Chlorine Gas]

The method for decomposing chlorine gas according to the present invention includes a step of bringing a gas containing chlorine gas into contact with a chlorine gas decomposition catalyst in the presence of water.

### [Chlorine Gas Decomposition Catalyst]

The chlorine gas decomposition catalyst is a chlorine gas decomposition catalyst including a ruthenium material (X), and the ruthenium material (X) includes at least one selected from the group consisting of ruthenium and a ruthenium compound.

### (Ruthenium Material (X))

The ruthenium material (X) includes at least one of ruthenium (metallic ruthenium) and a ruthenium compound.

Examples of the ruthenium compound include ruthenium oxide and a ruthenium alloy.

As the ruthenium oxide, RuO₂ is preferred in terms of catalytic activity to decompose chlorine gas and stability of the compound.

Examples of the ruthenium alloy include a Ru—Zr alloy. The mole ratio of ruthenium and zirconium in the ruthenium alloy is, in terms of mole of zirconium atoms relative to 1 mole of ruthenium atoms, 1 to 20 moles and more preferably 1 to 15 moles.

### (Support)

The chlorine gas decomposition catalyst may be a catalyst in which the ruthenium material (X) is supported on a support. In other words, the chlorine gas decomposition catalyst may be a chlorine gas decomposition catalyst including a support and the ruthenium material (X) supported on the support (hereinafter also referred to as a “supported type catalyst”). The chlorine gas decomposition catalyst that is a supported type catalyst generally has a larger specific surface area, and is therefore preferred from the viewpoint of improving catalytic activity.

The shape and size of the support are not particularly limited, but the support preferably has a structure in the form of, for example, a bead, pellet, powder, or granules, or a monolithic structure, and particularly preferably has a structure in the form of pellet.

The support is preferably composed of a porous material, and has a specific surface area as measured by BET method of, for example, 100 to 500 cm²/g and preferably 100 to 300 cm²/g.

A constituent of the support is preferably a component inert or less reactive to chlorine gas and hydrogen chloride produced by a decomposition reaction of the chlorine gas and includes, for example, alumina (Al₂O₃), silica (SiO₂), cordierite, or a zeolite and preferably alumina.

The average particle size (diameter) of the supports is, for example, 1 to 10 mm and preferably 2 to 5 mm.

### (Method for Producing Chlorine Gas Decomposition Catalyst)

Examples of a method for producing a chlorine gas decomposition catalyst free of a support among the chlorine gas decomposition catalysts include
a method for producing a chlorine gas decomposition catalyst, the method including a step of pulverizing and mixing powder of the ruthenium material (X) (i.e., pulverizing the powder and mixing the resulting crushed product), and
optionally a step of calcining the powder that was pulverized and mixed at 500 to 900° C. in air.

For pulverization and mixing of the powder of the ruthenium material (X), conventionally known methods such as using a ball mill and the like, can be adopted.

Examples of a method for producing the supported type catalyst among the chlorine gas decomposition catalysts include
a method for producing a chlorine gas decomposition catalyst, the method including a step (1) of preparing a support product in which a raw material component of the ruthenium material (X) is impregnated in the support (i.e., the support supporting the raw material component or a component containing a metal in the raw material component), and
a step (2) of calcining and/or reducing the support product to obtain a chlorine gas decomposition catalyst.

### Step (1)

Examples of the raw material component of the ruthenium material (X) include salts of Ru and salts of metal element(s) for forming an alloy with Ru. The salts may be hydrates.

Examples of the salts include nitrate, chloride, bromide, oxychloride, sulfate, and carbonate, with chloride and oxychloride being preferred.

Specific examples of the nitrate include ruthenium (III) chloride, tris(bipyridine) ruthenium (II) chloride, zirconium oxide chloride octahydrate, ruthenium (III) chloride, ruthenium dioxide, and ruthenium (IV) oxide.

The aforementioned step (1) is carried out, for example,
by a method including a step (11a) of dissolving the raw material components in water to prepare an impregnating solution; and
a step (12a) of bringing the impregnating solution and the support into contact with each other, and then recovering the obtained support product.

Examples of a method for bringing the impregnating solution into contact with the support to make the raw material component supported on the support, include conventionally known methods, such as impregnation methods (for example, a heating impregnation method, a room temperature impregnation method, a vacuum impregnation method, a normal pressure impregnation method, an impregnation drying method, and a pore filling method), an immersion method, a wet adsorption method, a spray method, a coating method, or combinations thereof.

Among these methods, the pore filling method is preferred from the viewpoints of making the raw material components supported with high dispersibility on the support, improvement in catalytic activity and facilitation of industrial implementation.

Bringing the impregnating solution and the support into contact with each other allows the raw material components to be stably supported with its high dispersibility on the surface of the support and further in pores thereof when the support is composed of a porous material.

The contact between the impregnating solution and the support may be carried out under atmospheric pressure or reduced pressure.

The contact between the impregnation liquid and the support may be carried out in the vicinity of room temperature (for example, 5 to 40° C.), or at higher temperatures by heating (for example, 40 to 85° C.).

The recovered support product is preferably dried. The drying can be carried out by a conventionally known means such as air drying and heating.

The drying is carried out, for example, under the following conditions.
Temperature: Temperature at which supported material components do not decompose (for example, room temperature to 300° C.).
Time: 0.5 to 50 hours.
Pressure: At ordinary or reduced pressure.
Atmosphere: Air, inert gases (for example, argon gas, nitrogen gas, and helium gas), oxygen gas, or a mixture of these gases.

### Step (2)

In step (2), the support product obtained in step (1) is calcined and/or reduced to obtain a chlorine gas decomposition catalyst.

Calcination and reduction are carried out, for example, under the following conditions.
Temperature: 300 to 1200° C. and preferably 400 to 800° C.
Time: 0.5 to 10 hours and preferably 1 to 3 hours.
Pressure: Ordinary pressure, reduced pressure or pressurized pressure.
Atmosphere: air, inert gas (for example, argon gas, nitrogen gas, or helium gas), oxygen gas, reducing gas (for example, hydrogen gas), or a mixed gas thereof (for example, a mixed gas of hydrogen and nitrogen).

In the catalyst obtained by this calcination or reduction, a component containing ruthenium is supported on a support in a highly dispersed state in the form of metallic ruthenium, a ruthenium alloy, or an oxide or a composite oxide of ruthenium.

### [Decomposition Step of Chlorine Gas]

As described above, the method for decomposing chlorine gas according to the present invention includes a step of bringing the gas containing chlorine gas into contact with the chlorine gas decomposition catalyst in the presence of water.

Bringing the gas containing chlorine gas into contact with the chlorine gas decomposition catalyst in the presence of water causes the following reaction and enables decomposition of chlorine gas.

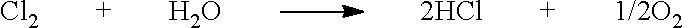

The proportion of chlorine gas in the gas containing chlorine gas is, for example, 0.1 to 10% by volume and preferably 0.1 to 1% by volume at 25° C. and 1 atmospheric pressure.

The gas containing chlorine gas preferably contains water. The proportion of water in the gas containing chlorine gas is, for example, 1 to 40% by volume and preferably 10 to 25% by volume. The volume described here is a value that is converted under standard conditions (0° C., 1.01×10⁵ Pa).

Examples of gases other than chlorine gas and water vapor in the gas containing chlorine gas include, for example, nitrogen gas and argon gas.

The decomposition reaction of chlorine gas is carried out, for example, under the following conditions.
Temperature: 300 to 1,000° C. and preferably 400 to 800° C.
Pressure: Ordinary pressure or pressurized pressure and preferably ordinary pressure.

According to the method for decomposing chlorine gas according to the present invention, it is possible to decompose chlorine gas and particularly chlorine gas contained in exhaust gas, at a high decomposition rate.

According to the method for decomposing chlorine gas according to the present invention, it is possible to decompose even chlorine gas contained in exhaust gas containing perfluoro compound gas described later at a high decomposition rate.

### [Removal Method of Chlorine Gas]

The method for removing chlorine gas according to the present invention is a method for removing chlorine gas contained in exhaust gas, and
includes a step of removing the chlorine gas by decomposing the chlorine gas using the method for decomposing chlorine gas according to the present invention.

The method for removing chlorine gas according to the present invention will be described in more detail using an example in which the method is carried out using an exhaust gas treatment apparatus described below.

The exhaust gas treatment apparatus that can be used in the method for removing chlorine gas according to the present invention includes a vessel into which exhaust gas containing chlorine gas is introduced, i.e., a reactor, and the reactor is equipped with the chlorine gas decomposition catalyst.

The exhaust gas treatment apparatus will be described with reference to the drawings.

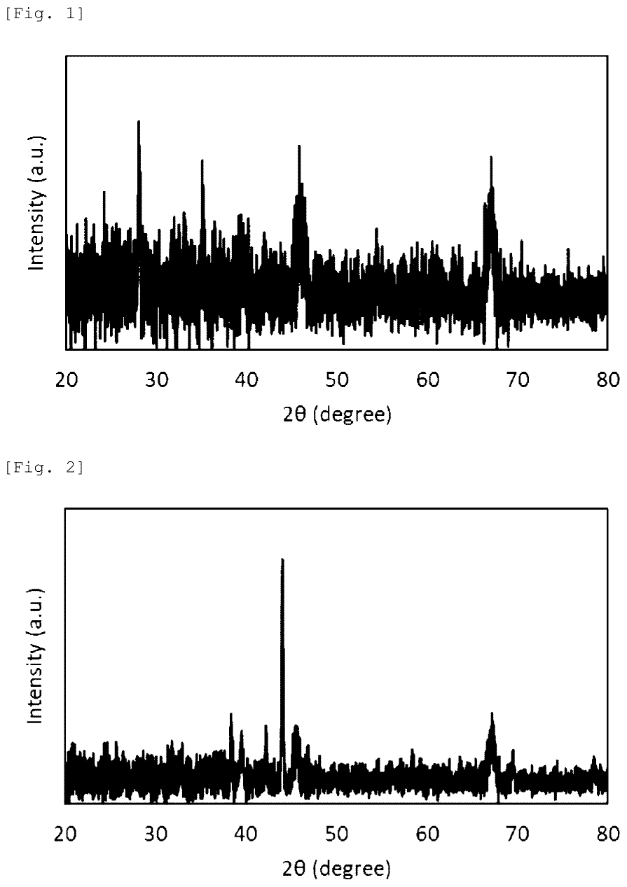

FIG. 1 is a configuration view of one aspect of the exhaust gas treatment apparatus. The exhaust gas treatment apparatus 1 of the present embodiment includes a first removal device (also referred to as a “scrubber”) 2 in which scrubber water b1 is poured by, for example, a spray (not shown) into exhaust gas a containing chlorine gas, a reactor 4 into which the exhaust gas that has passed through the first removal device 2 is introduced via a pipe 9 and into which water b is also introduced to carry out a decomposition reaction of chlorine gas in the exhaust gas, a cooling device 6 that cools the exhaust gas that has passed through the reactor 4, a second removal device (also referred to as a “scrubber”) 7 in which scrubber water b1 is poured by, for example, a spray (not shown) into the exhaust gas that has passed through the cooling device 6, and a blower 8 for sending the treated exhaust gas that has passed through the second removal device 7 out of the system via a pipe 10.

The inside of the reactor 4 is filled with the chlorine gas decomposition catalyst 3, and a heating device 5 is installed in a circumference of the reactor 4.

The reactor 4 can be appropriately sized depending on, for example, a type of the exhaust gas a, a scale of the exhaust gas treatment apparatus 1.

Examples of the exhaust gas a include gases discharged from, for example, processes for manufacturing compounds and various industrial processes, and examples of such gases include a greenhouse gas (GHG), a harmful gas, a flammable gas, and an odorous gas. Specific examples thereof include etching gases used in processes for manufacturing semiconductors or liquid crystals, or cleaning gases used in CVD apparatus. These exhaust gases may contain a perfluoro compound. Examples of the perfluoro compounds include CF₄, CHF₃, C₂F₆, C₃F₈, C₄F₈, SF₆, and NF₃.

The exhaust gas treatment apparatus 1 may include a reactor (not shown) filled with a perfluoro compound decomposition catalyst 9 (not shown) together with the reactor 4 filled with the chlorine gas decomposition catalyst 3. The perfluoro compound decomposition catalyst 9 may be a conventionally known catalyst, for example, a nickel oxide catalyst.

Use of the chlorine gas decomposition catalyst according to the present invention as the chlorine gas decomposition catalyst 3 and combined use of the reactor 4 containing the chlorine gas decomposition catalyst 3 and a reactor (not shown) containing the perfluoro compound decomposition catalyst 9, that is, use of the exhaust gas treatment apparatus 1 configured so that the exhaust gas a passes through one reactor and then the other reactor, enables decomposing not only perfluoro compounds but also chlorine gas with high efficiency even when the exhaust gas a contains a perfluoro compound.

The exhaust gas treatment apparatus 1 preferably includes a supply device that supplies water b to the exhaust gas a introduced into the reactor 4. Including this supply device enables carrying out the above-described decomposition reaction of chlorines gas smoothly even in a case in which the exhaust gas a is originally free of water. Examples of the device that supplies water include a device that transfers water using a pump or a compressor and sprays it from a nozzle.

The exhaust gas treatment apparatus 1 preferably includes a heating device 5 for heating an exhaust gas containing chlorine gas to a temperature at which a decomposition reaction of chlorine gas is carried out. Examples of the heating device 5 include an electric heater 5a that uses electric energy for heating, and a heating device that passes high-temperature gas through.

For example, the reactor 4 may include the heating device 5 (for example, the heating device 5 installed in the circumference of the reactor) for heating an inside of the reactor 4 to a temperature at which a decomposition reaction of chlorine gas is carried out, or the exhaust gas treatment apparatus 1 may include a heating device (not shown) for heating an exhaust gas containing chlorine gas to a temperature at which a decomposition reaction of chlorine gas is carried out before the gas is introduced into the reactor 4.

The exhaust gas treatment apparatus 1 is preferably equipped with a cooling device 6 that cools gas discharged from the reactor 4. Examples of this cooling device 6 preferably include a device that brings the gas into contact with cooling water in the cooling device 6 (for example, a spray for spraying cooling water b2). By bringing the gas into contact with cooling water, hydrogen chloride, which is a product of decomposition reaction of chlorine gas contained in the gas, and further hydrogen fluoride, which is a product of the decomposition reaction of a perfluoro compound when the exhaust gas a contains it, can be dissolved into the cooling water and removed.

The exhaust gas treatment apparatus 1 preferably includes an abatement device (not shown) that abates cooling water (hereinafter also referred to as “exhaust liquid”) in which hydrogen chloride, for example, is dissolved. The exhaust liquid and scrubber water b1 are recovered through a pipe 11, and preferably sent out of the system after having been abated.

The exhaust gas treatment apparatus 1 preferably includes a removal device (for example, a second removal device 7) that removes an acid gas (hydrogen chloride gas, hydrogen fluoride gas) from gas discharged from the reactor 4 and passed through the cooling device 6.

The exhaust gas treatment apparatus preferably includes a temperature detector that detects the temperature of the exhaust gas a supplied to the reactor 4, and a control device (for example, a computer) that controls the heating device 5 based on the temperature measured by the temperature detector. Controlling the heating device 5 means that, for example, adjusting current of the electric heater 5a, and thereby maintaining the temperature at which a decomposition reaction of chlorine gas is carried out.

When the exhaust gas treatment apparatus 1 is used to treat perfluoro compound gas containing chlorine gas, the exhaust gas treatment apparatus 1 preferably includes an abatement device (not shown) that abates the perfluoro compound gas.

When the exhaust gas a contains perfluoro compound gas, it is preferable to decompose chlorine gas and the perfluoro compound by, for example, a catalyst or plasma to abate the exhaust gas a and then discharge the abated exhaust gas c generated from the exhaust gas a to an outside of the system. Herein, the abated exhaust gas c refers to exhaust gas in which chlorine gas is significantly reduced in amount compared to the exhaust gas a. Furthermore, before the abated exhaust gas c and abated exhaust liquid d are discharged to an outside of the system, a perfluoro compound as well as a compound generated by decomposing chlorine gas and the perfluoro compound may preferably undergo abatement treatment, if necessary. Also, after the abated exhaust gas c and abated exhaust liquid d are discharged to an outside of the system, the perfluoro compound and compound generated by decomposing chlorine gas and the perfluoro compound may undergo abatement treatment.

Conventional methods for removing chlorine gas using an adsorbent have had an inconvenience of requiring frequent exchange of the adsorbent. However, the method for decomposing chlorine gas according to the present invention makes it possible to remove chlorine gas without frequent exchange of the catalyst.

### EXAMPLES

Hereinafter, the present invention will be further specifically described based on the Examples, but the present invention is not limited to the Examples.

### (Raw Materials)

The raw materials used in, for examples, the following Examples are as follows:
Zirconium oxide chloride octahydrate (manufactured by FUJIFILM Wako Pure Chemical Corporation)
Ruthenium (III) chloride·n-hydrate (manufactured by Tanaka Kikinzoku Kogyo K. K.)
Porous γ-alumina (3 mm diameter, spherical, γ-Al₂O₃)

### Catalyst Fabrication

### Production Example 1

1.6 g of ruthenium (III) chloride were dissolved in 80.5 mL of pure water to obtain an aqueous solution (impregnating solution). The pore filling method was performed, i.e., 60.0 g of porous γ-alumina as a support was placed in this aqueous solution (impregnating solution), and the porous γ-alumina was brought into contact with ruthenium chloride to obtain a support product (1) (the porous γ-alumina supporting ruthenium chloride).

The support product (1) was air-dried at room temperature for 1 hour, further dried at 60° C. for 24 hours, and then calcined in air at 500° C. for 2 hours to obtain a chlorine gas decomposition catalyst (1) including ruthenium oxide (hereinafter also referred to as “Ru oxide”).

### Production Example 2

A support product (1) was obtained in the same manner as in Production Example 1.

The support product (1) was air-dried at room temperature for 1 hour, and then further dried at 60° C. for 24 hours, and then reduced in a mixed gas of 4% by volume hydrogen and 96% by volume nitrogen at 800° C. for 4 hours to obtain a chlorine gas decomposition catalyst (2) including metallic ruthenium (hereinafter also referred to as “Ru”).

### Production Example 3

A chlorine gas decomposition catalyst (3) including a ruthenium-zirconium alloy (hereinafter also referred to as “Ru—Zr”) was obtained in the same manner as in Production Example 2, except that 1.6 g of ruthenium (III) chloride was changed to 0.8 g of ruthenium (III) chloride and 15.7 g of zirconium oxide chloride octahydrate.

### Comparative Production Example 1

16.3 g of nickel (II) nitrate hexahydrate were dissolved in 53 mL of pure water to obtain an aqueous solution (impregnating solution). The pore filling method was performed, i.e., 39.0 g of porous γ-alumina as a support was placed in this aqueous solution (impregnating solution), and the porous γ-alumina was brought into contact with nickel nitrate to obtain a support product (c1).

A chlorine gas decomposition catalyst (c1) including nickel oxide (hereinafter also referred to as “Ni oxide”) was obtained in the same manner as in Production Example 1, except that the support product (1) was changed to the support product (c1).

### Comparative Production Example 2

A chlorine gas decomposition catalyst (c2) including iron oxide (hereinafter also referred to as “Fe oxide”) was obtained in the same manner as in Comparative Production Example 1, except that 16.3 g of nickel (II) nitrate hexahydrate was changed to 22.6 g of iron (III) nitrate nonahydrate.

### (Analysis of Catalyst)

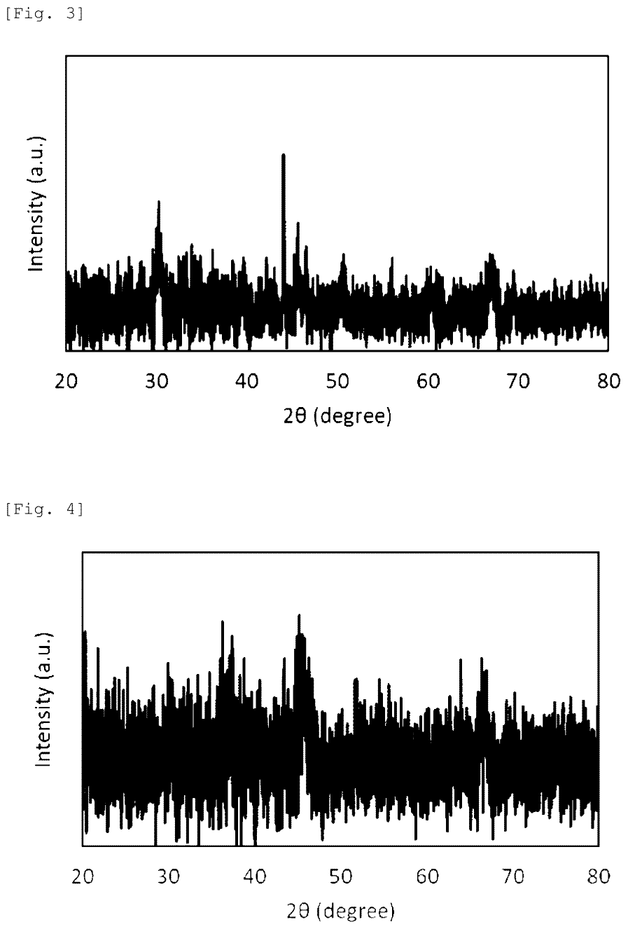

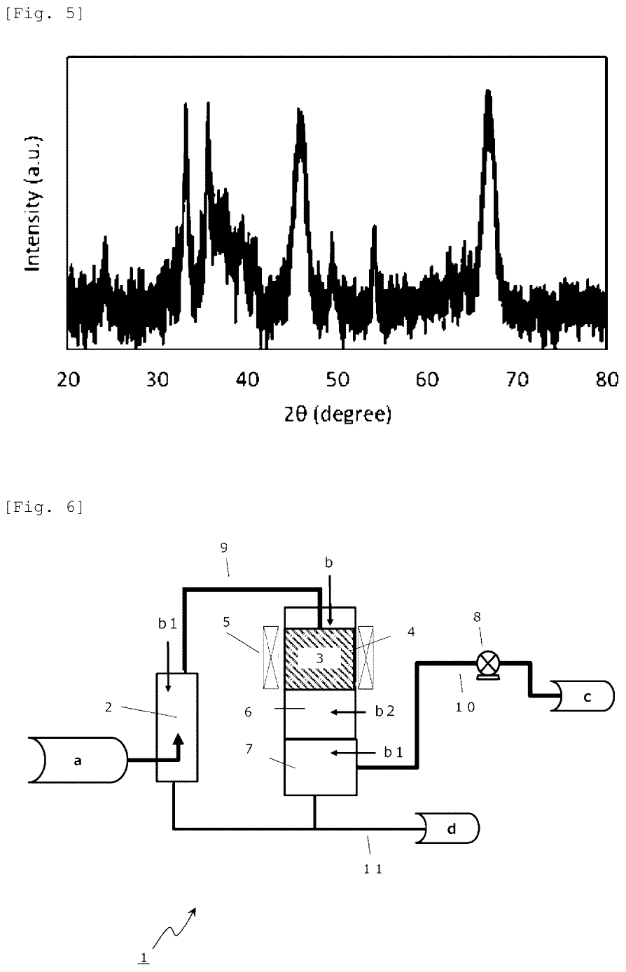

As a result of XRD measurements of the chlorine gas decomposition catalysts obtained in each production example and comparative production example, oxides including each metal component such as ruthenium, a ruthenium alloy, and ruthenium oxide were confirmed as shown in FIGS. 1 to 5.

### (Powder X-Ray Diffraction (XRD) Measurement)

The method of XRD measurements is as follows.

The obtained catalyst was pulverized by using an agate mortar for 10 minutes to obtain powder for XRD measurements. By using a powder X-ray diffractometer (PANAlytical MPD manufactured by Spectris pls.), X-ray diffraction measurements of the obtained powder for XRD measurement (Cu-Kα ray (output 45 kV, 40 mA), diffraction angle 2θ=10 to 80° range, step width: 0.013°, incident side Soller slit: 0.04 rad, incident side Anti-scatter slit: 2°, receiving side Soller slit: 0.04 rad, receiving side Anti-scatter slit: 5 mm) were carried out to obtain X-ray diffraction (XRD) patterns.

### Example 1

### (Method for Decomposing Chlorine Gas)

An reaction tube made of Inconel (volume 70 cc) was filled with the chlorine gas decomposition catalyst obtained in Production Example 1 so that the inside of the reaction tube was filled up with the catalyst. Upon the reaction, the volume of each gas was adjusted so that a mixed gas had a volume ratio of chlorine gas:nitrogen gas:water vapor in the reaction tube of 0.5:74.5:25 (in terms of volumes at 0° C. and 1.01×10⁵ Pa), and the mixed gas was supplied into the reaction tube at 5,000 cc/min (in terms of volume at 0° C. and 1.01×10⁵ Pa) under ordinary pressure. Specifically, chlorine gas and nitrogen gas were mixed by adjusting their volume ratio using a mass flow controller, and the gas with this flow rate being adjusted was introduced into the reaction tube. Pure water at ordinary temperature was introduced by a pump into a preheating section (400° C.) from an inlet different from an inlet for mixed gas, while measuring its weight so as to achieve the above volume ratio, then vaporized and introduced into the reaction tube to be merged with the mixed gas of chlorine gas and nitrogen gas. The reaction tube was heated to 500° C. in an electric furnace, and at the time of 1 hour after the start of the reaction, the gas at an outlet of the reaction tube was sampled by distributing it through a potassium iodide aqueous solution, and the amount of chlorine gas was quantified by an iodine titration method, and a decomposition rate of chlorine gas was measured as defined in the formula below.

$$Decomposition rate ( \% ) = \{ ( 0.5 - proportion of chlorine gas in outlet gas ( \% by volume ) ) / 0.5 \} \times 100$$

wherein the proportion of chlorine gas in the outlet gas was converted to a proportion under standard conditions (0° C. and 1.01×10⁵ Pa).

The results are shown in Table 1.

### Examples 2 and 3 and Comparative Examples 1 and 2

Each chlorine gas was decomposed in the same manner as in Example 1, except that the chlorine gas decomposition catalyst obtained in Production Example 1 was replaced with the chlorine gas decomposition catalyst obtained in Production Example 2 or 3, or Comparative Production Example 2 or 3.

The results are shown in Table 1.

TABLE 1

| | | | | Chlorine gas decomposition | | |
|---|---|---|---|---|---|---|
| | | | | conditions | | Chlorine gas |
| | Catalyst | | | Chlorine gas | Decomposition | decomposition |
| | Catalyst type | | Support | concentration | temperature | ratio |
| Example 1 | (1) | Ru oxide | γ-Alumina | 0.5% by | 500° C. | 98.4% |
| Example 2 | (2) | Ru | | volume | | 98.7% |
| Example 3 | (3) | Ru—Zr | | | | 97.7% |
| Comparative | (c1) | Ni oxide (NiO) | | | | 56.5% |
| Example 1 | | | | | | |
| Comparative | (c2) | Fe oxide (Fe₂O₃) | | | | 54.3% |
| Example 2 | | | | | | |

### REFERENCE SIGNS LIST

1. Exhaust gas treatment apparatus
2. First removal device (scrubber)
3. Chlorine gas decomposition catalyst
4. Reactor
5. Heating device
6. Cooling device
7. Second removal device (scrubber)
8. Blower
9, 10, 11. Pipes
a. Exhaust gas
b. Water
b1. Scrubber water
b2. Cooling water
c. Abated exhaust gas
d. Abated exhaust liquid

1. A method for decomposing chlorine gas, comprising a step of bringing a gas containing chlorine gas into contact with a chlorine gas decomposition catalyst in the presence of water, wherein the chlorine gas decomposition catalyst comprises a ruthenium material (X), and the ruthenium material (X) comprises at least one selected from the group consisting of ruthenium and a ruthenium compound.

2. The method for decomposing chlorine gas according to claim 1, wherein the ruthenium material (X) comprises ruthenium.

3. The method for decomposing chlorine gas according to claim 1, wherein the ruthenium material (X) comprises a Ru—Zr alloy as the ruthenium compound.

4. The method for decomposing chlorine gas according to claim 1, wherein the ruthenium material (X) comprises ruthenium oxide as the ruthenium compound.

5. The method for decomposing chlorine gas according to claim 1, wherein the chlorine gas decomposition catalyst comprises a support and the ruthenium material (X) supported on the support.

6. A method for removing chlorine gas contained in exhaust gas, comprising a step of removing the chlorine gas by decomposing the chlorine gas using the method for decomposing chlorine gas according to claim lany one of claims 1 to 5.

7. A method for removing chlorine gas contained in exhaust gas, comprising a step of removing the chlorine gas by decomposing the chlorine gas using the method for decomposing chlorine gas according to claim 2.

8. A method for removing chlorine gas contained in exhaust gas, comprising a step of removing the chlorine gas by decomposing the chlorine gas using the method for decomposing chlorine gas according to claim 3.

9. A method for removing chlorine gas contained in exhaust gas, comprising a step of removing the chlorine gas by decomposing the chlorine gas using the method for decomposing chlorine gas according to claim 4.

10. A method for removing chlorine gas contained in exhaust gas, comprising a step of removing the chlorine gas by decomposing the chlorine gas using the method for decomposing chlorine gas according to claim 5.
